(19) United States
(12) Patent Application Publication
(10) Pub. No.: US 2011/0314754 A1
(43) Pub. Date: Dec. 29, 2011

(54) FRAME AND DOOR ASSEMBLY SYSTEM AND METHOD

(76) Inventor: Stephen Griffin, Kerry (IE)

(21) Appl. No.: 13/255,866

(22) PCT Filed: Mar. 11, 2010
(86) PCT No.: PCT/EP2010/001525

§ 371 Date: Sep. 9, 2011

(30) Foreign Application Priority Data
Mar. 11, 2009 (GB) 0904197.1

(51) Int. Cl. E06B 1/52; E04C 3/02; E06B 1/00; E05D 5/04; E06B 1/04

(52) U.S. Cl. 52/204.2; 16/387; 52/204.1; 52/211; 52/745.15

(57) ABSTRACT

The invention provides door frame assembly, suitable for hanging a door panel in a number of different positions. The invention is characterised such that a side wall of the frame is routered on front and rear faces, either face adapted to receive one plate of a door hinge. In addition one edge of the door panel is routered across the entire length of the edge to receive a second plate of said hinge, wherein the outer edge of the second plate comprises a bull nosed edge. The advantage of the door frame assembly according to the invention is the routering both sides of the panel allows it to be reversed depending on which way one wishes to hang the door. As the door panel edge is routered across the entire edge allows the hinge to hang the door in the frame in either direction.

### FIELD OF THE INVENTION

The present invention relates generally to building construction. In particular the invention relates to the hanging of doors in the construction of buildings.

### BACKGROUND TO THE INVENTION

Construction, including improvements to existing buildings as well as new construction, have led to a demand for more simplified and more economical building materials, components and techniques. One particular segment of the increased volume which has exhibited widespread growth is the field of home improvement where a great deal of the work is accomplished by carpenters and builders seeking easier and more foolproof procedures reducing time and thus reducing cost. In response to the demand, the building supply industry has offered various modular door and frame assemblies in which a good deal of the operations which require more skill and specialized tools are completed in the factory, leaving only less complex procedures for the installer in the field.

Among the more successful assemblies offered for building construction is the pre-hung door assembly in which a door is fully prepared for the reception of latching hardware and is hinged in a door frame so that all the installer need do is mount the door frame within a prepared building wall in order to achieve a properly hung door. The precision with which the door is located and hung within the frame and the accuracy with which the door is prepared for the reception of latching hardware is maintained at a high level by virtue of accomplishing those operations in the factory, with specialized manufacturing tooling, leaving little to chance and to the less sophisticated tools and procedures available to installers in the field.

In order to accommodate the requirement for both right-hand and left-hand openings, it has been necessary to supply pre-hung door assemblies in both configurations, enabling an installer to select the appropriate assembly for a particular installation. The necessity to make available pre-hung door assemblies in both hands essentially doubles the number of assemblies which must be made available by the manufacturer and by the distributor and retailer, requiring larger inventories and the concomitant dedication of greater amounts of space, both for storage and on the selling floor.

However, modular door assemblies present particular difficulties of their own. Specifically, there is scope for confusion as to the handedness of the door. Door sets are not symmetrical, as a door can open on the left-hand side or the right-hand side. In addition, the door can open inwardly or outwardly. It would be apparent that an inward opening door hinged on the left is physically identical to an outward opening door hinged on the right. The same applies to inward opening doors hinged on the right and outward opening doors hinged on the left. However, this presents difficulty in definition, since designers will normally specify, for example a “left-hinged door” which can be of either configuration. It is not unknown for door sets to be supplied to site only to find that the orders have been reversed and further supplies are needed. Examples of compelex door assemblies are disclosed in patent literature, for example FR2268970, US2004/0016182, U.S. Pat. No. 5,832,670 and WO2005/033458. None of these door assemblies offer an effective simple solution for reversing a door in a door frame.

In addition, problems in the installation and design of doors often only become apparent when they are fitted on site. Clashes between nearby doors or between doors and other fittings may not have been noticed at the design stage. If this happens, the door set must often be scrapped and replaced with an opposite door set.

There is therefore a need to provide door and frame assembly system and method to overcome the above mentioned problems.

### SUMMARY OF THE INVENTION

According to the invention there is provided, as set out in the appended claims, a door frame assembly, suitable for hanging a door panel in a number of different positions, comprising:

at least one side wall support to form part of the frame to provide a support to hang a door panel using at least one hinge, characterised in that:
the side wall support is routered on front and rear faces, either face adapted to receive one plate of said hinge; and
one edge of the door panel is routered across the entire thickness (or width) of the edge to receive a second plate of said hinge, wherein the outer edge of the second plate comprises a bull nose edge.

The advantage of the door frame assembly according to the invention is the routering both sides of the hinged wall support which then allows it to be reversed depending on which way one wishes to hang the door. In addition as the door edge is routered across the entire thickness (or edge) therefore allows the hinge to hang the door in the frame in either direction. An important aspect of the invention is that the bull nose edge on the hinge, which matches the bull nose edge of a door, and in turn cancels out the risk of splinters at the edge of the door. The term ‘bull nose’ is used in the context of the invention to provide a smooth, rounded edge for countertops, building corners, or other types of construction.

In one embodiment a second side wall support of the frame comprises a routered portion to receive a receiver plate.

In one embodiment the second side wall support is routered on opposing faces, both faces adapted to receive the receiver plate.

In one embodiment there is optionally provided an adjustable architrave for attaching into the door frame. Alternatively a flat jamb may also be used and therefore an architrave with no adjustment is required.

In one embodiment the adjustable architrave comprises a leg for engaging the door frame to suit different block/stud wall dimensions. Alternatively a flat jamb may also be used and therefore an architrave with no adjustment is required.

In one embodiment the side wall supports each comprise a ‘finished’ veneer on all surfaces of the side wall supports. In another embodiment the side wall supports can be made of solid wood or multi layered veneered wood.

In one embodiment one edge of the door panel comprises a bull nosed edge to match the bull nosed of the hinge to provide a smooth surface. Optionally one edge of the door panel comprises a smooth chamfered edge.

In one embodiment a support header comprises means to engage the side walls to form said door frame. The means to engage comprises a single screw at each end of the support header, such that each single screw is centred across the width of the support header to allow the side wall to pivot on its axis to reverse the side wall as necessary.

In one embodiment the means to engage comprises a single screw at each end of the support header. Extra screws can be added after handedness of door is decided, this will secure the door jambs and resist the door jambs twisting. Two or more screws can provide extra strength of the frame assembly.

In one embodiment the hinge comprises optional bearings. The optional bearings means that the hinge does not have to have a pin or pins.

In one embodiment the part of the hinge to engage with the door panel is dimensioned to be substantially equal the width of the door panel. It will be appreciated that the term door panel should be interpreted broadly, and to mean any type of door.

In one embodiment the hinge comprises the first plate and second plates.

In one embodiment the first plate is releasably connectable to the second plate of the hinge.

In one embodiment the connection is by way of a removable pin which passes through a receptor means on each part.

In another embodiment there is provided a hinge suitable for incorporating in the door assembly as hereinbefore described, said hinge comprising at least one plate, wherein one edge of the plate comprises a bull nose edge.

### BRIEF DESCRIPTION OF THE DRAWINGS

The invention will be more clearly understood from the following description of an embodiment thereof, given by way of example only, with reference to the accompanying drawings, in which:—

FIG. 1 illustrates the door frame components according to one aspect of the invention;

FIG. 2 illustrates the door frame components according to another aspect of the invention;

FIG. 3 illustrates a side view of the door frame of FIG. 2;

FIG. 4a illustrates a plan view of the door frame of FIGS. 1 and 2;

FIG. 4b illustrates an alternative plan view of the door frame of FIGS. 1 and 2;

FIG. 5 illustrates a reversible door hinge for use in the door frame assembly;

FIG. 6 illustrates a further aspect of the door frame assembly;

FIGS. 7a-7d illustrates various steps of the door frame and door into an assembled position;

FIGS. 8a-8d illustrates various steps of reversing the door in the door frame; and

FIG. 9 illustrates a view of the door in the frame according to the invention.

### DETAILED DESCRIPTION OF THE DRAWINGS

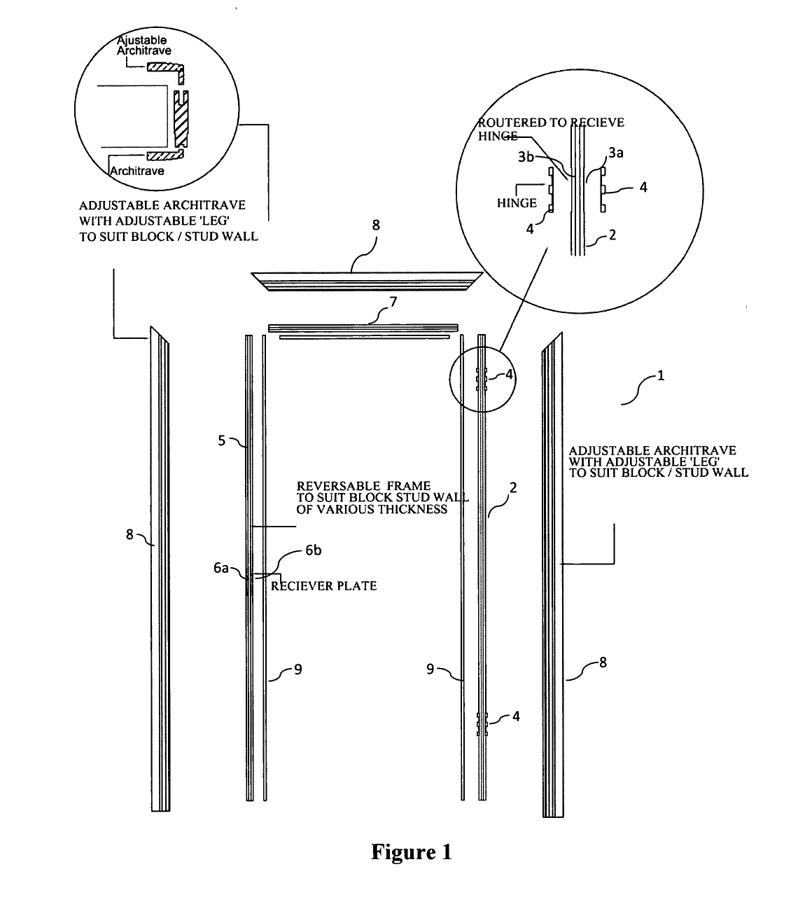

Referring to the drawings and initially to FIG. 1 there is illustrated a door frame assembly for hanging a door panel according to the invention indicated generally by the reference numeral 1.

A side wall support 2 makes up part of the frame assembly 1 and is routered on front and back faces 3a and 3b to receive a hinge plate 4. A second side wall support 5 of the frame comprises a routered portion to receive a receiver plate 6. The second side wall support is routered on opposing faces 6a and 6b, both faces are adapted to receive the receiver plate. A support header 7 comprises means to engage the side walls to form the door frame, according to the invention. An adjustable architrave 8 can be affixed to the door frame or a plant on architrave can also be fixed on to a flat jamb door frame. A door stop 9 can be attached to the inner surface of the supports 2, 5 and 7.

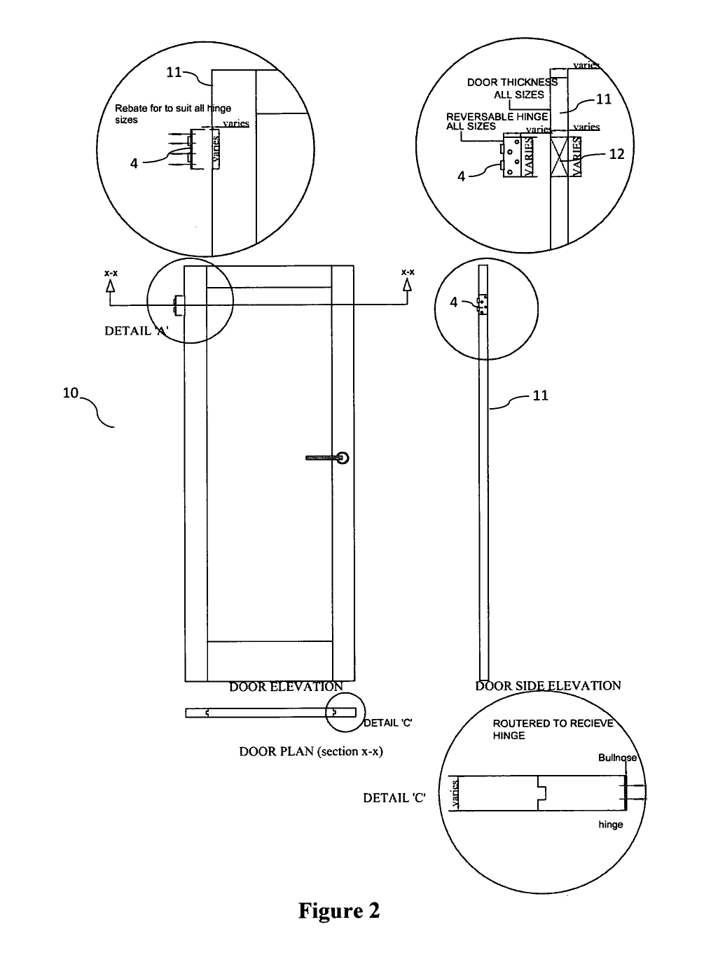

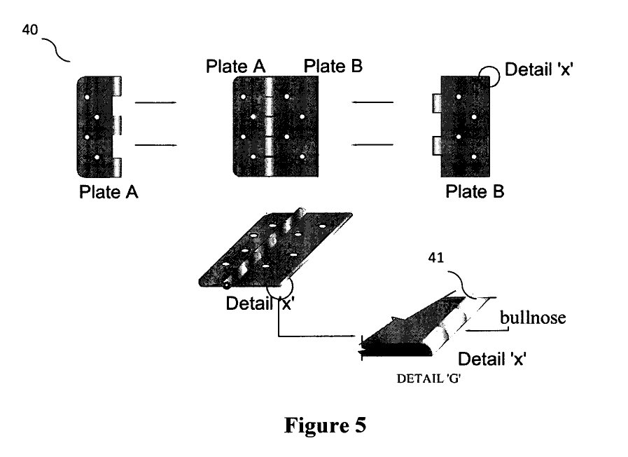

FIG. 2 illustrates a door panel according to the invention indicated generally by the reference numeral 10. One edge of the door panel 11 is routered across the entire thickness of the door panel edge 12 to receive a second plate of the hinge 4. The outer edge of the second plate comprises a bull nosed edge, discussed in more detail in FIG. 5 below.

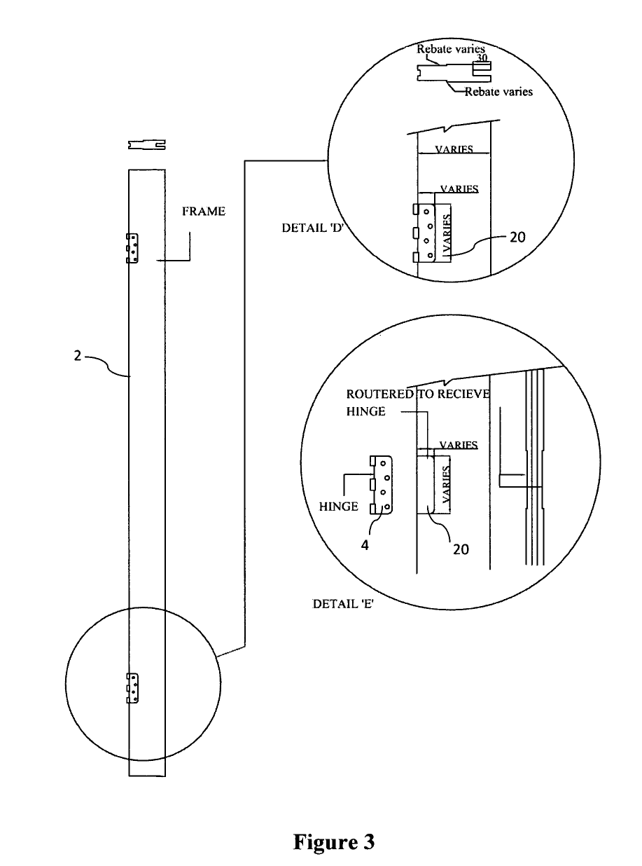

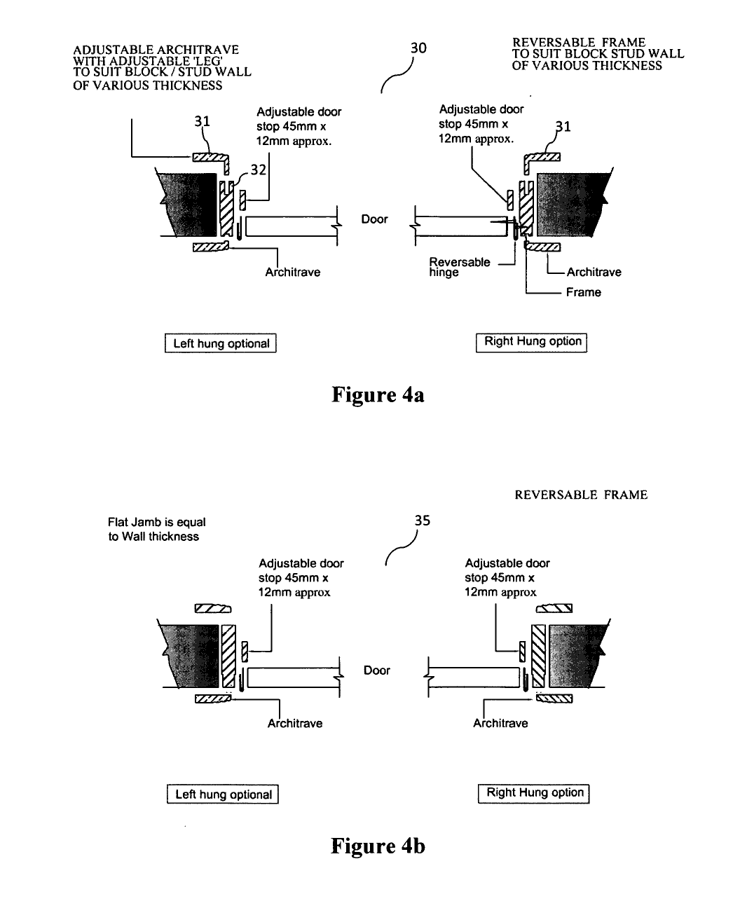

FIG. 3 illustrates a side view of the side wall support 2 showing the hinge plate 4 attaching to the routered portion 20 of the side wall support 2. It will be appreciated that the routered portion 20 can be of any suitable width or depth depending on application required. FIG. 4a shows a plan view of the adjustable architrave 30 according to another aspect of the invention for attaching to around the door frame 2, 5 and 7. The adjustable architrave comprises a leg 31 for engaging the door frame 2 or 5 in a groove 32 to suit different block/stud wall dimensions as required. FIG. 4b illustrates an alternative plan view of the door frame indicated by the reference numeral 35 showing a plant on architrave can also be fixed on to a flat jamb door frame.

FIG. 5 illustrates different views of a reversible hinge according to an another aspect of the invention indicated generally by the reference numeral 40. The hinge comprises the first plate and second plates. The part of the hinge to engage with the door panel is dimensioned to be substantially equal the width of the door panel. on the edge of the door, where the door is to be hung is routered across the entire thickness of the edge to receive plate “B” of said hinge, as shown FIG. 5. The outer edge of the plate B comprises a bull nose edge (see detail X), which copies the bull nose edge of a door, and in turn cancels out the risk of splinters at the edge of the door to provide a smooth contour even edge surface. The bull nose edge of the hinge can be easily seen in the 3D perspective view of part of the hinge illustrated by the reference numeral 41. The first plate can be releasably connectable to the second plate of the hinge. The connection can be by way of a removable pin which passes through a receptor means on each part. Alternatively in another embodiment the hinge comprises optional bearings where the hinge has no pins (not shown).

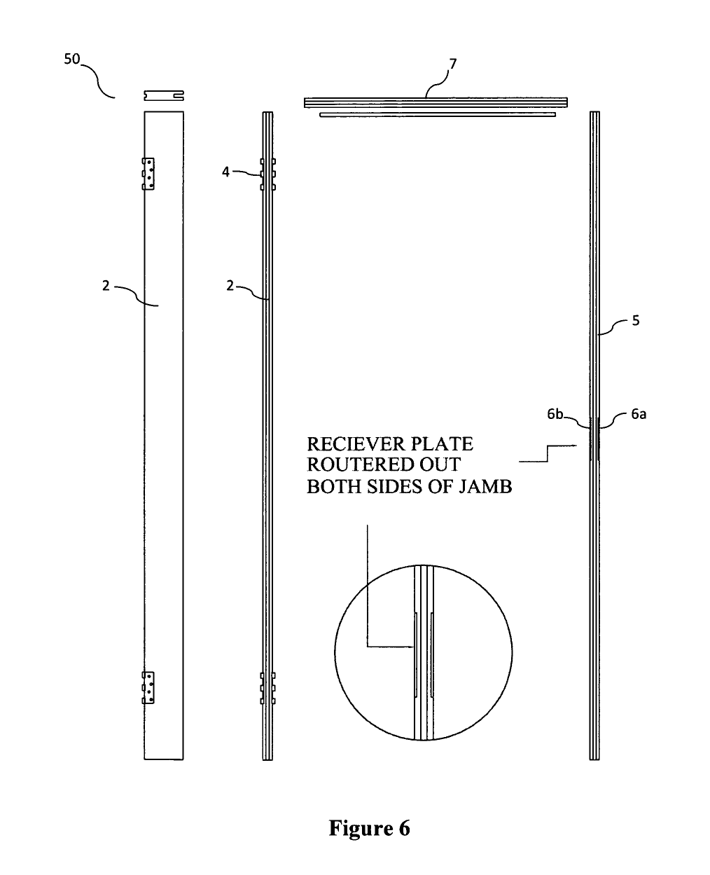

Referring to FIG. 6 there is illustrated different elements of the door frame before been assembled indicated generally by the reference numeral 50.

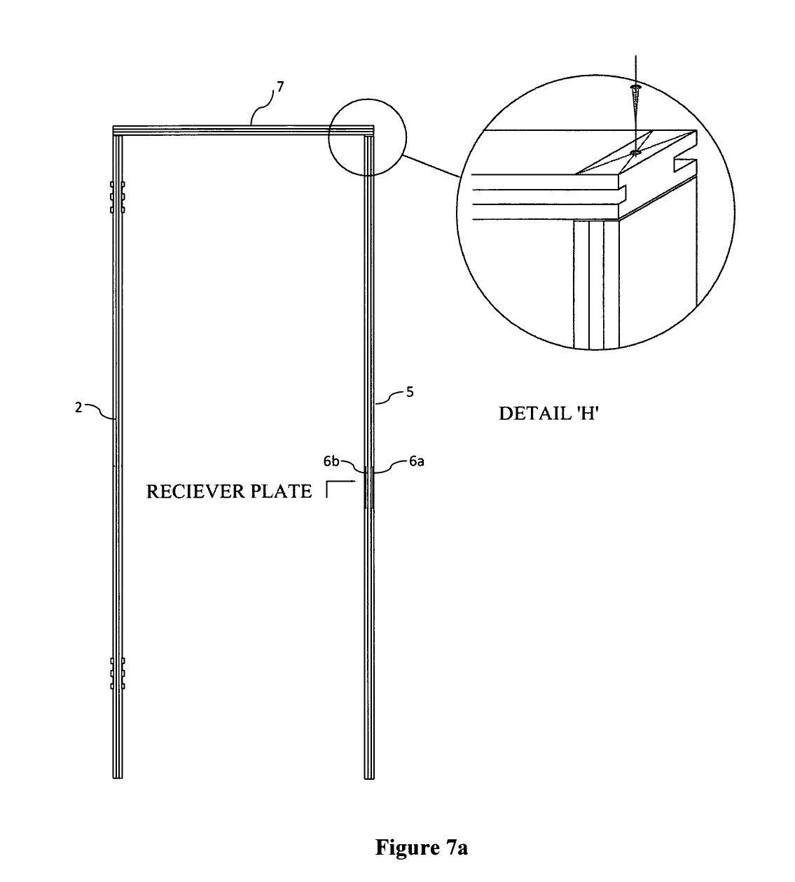

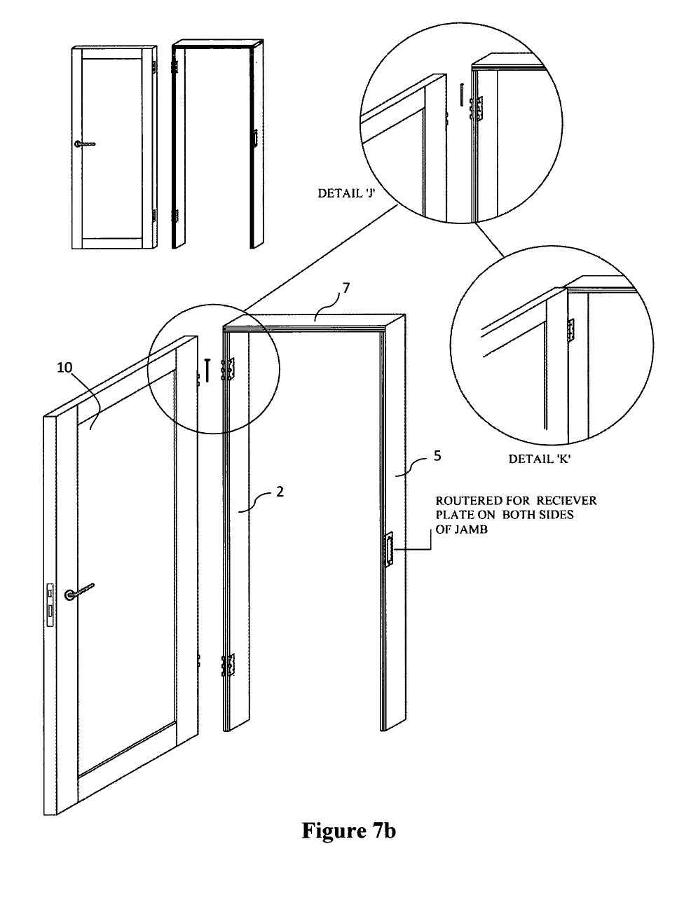

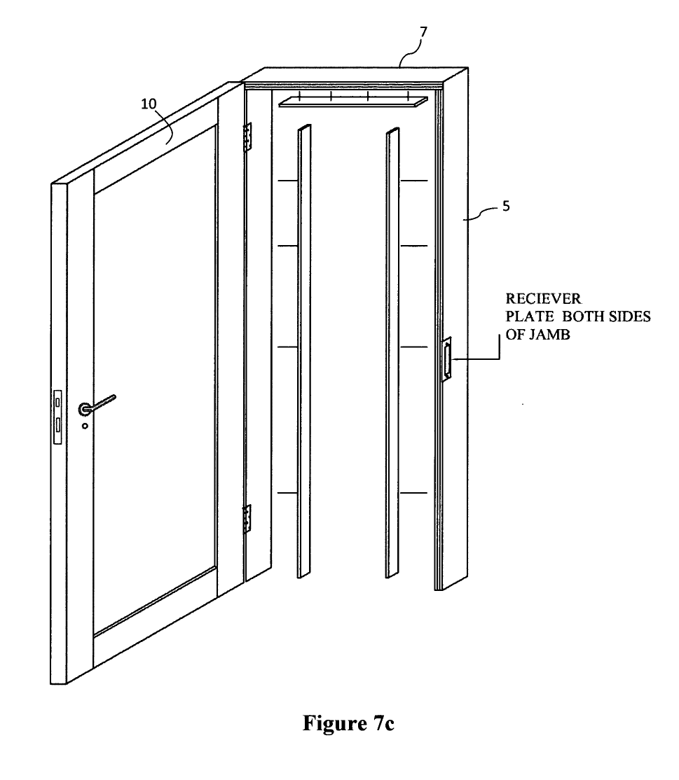

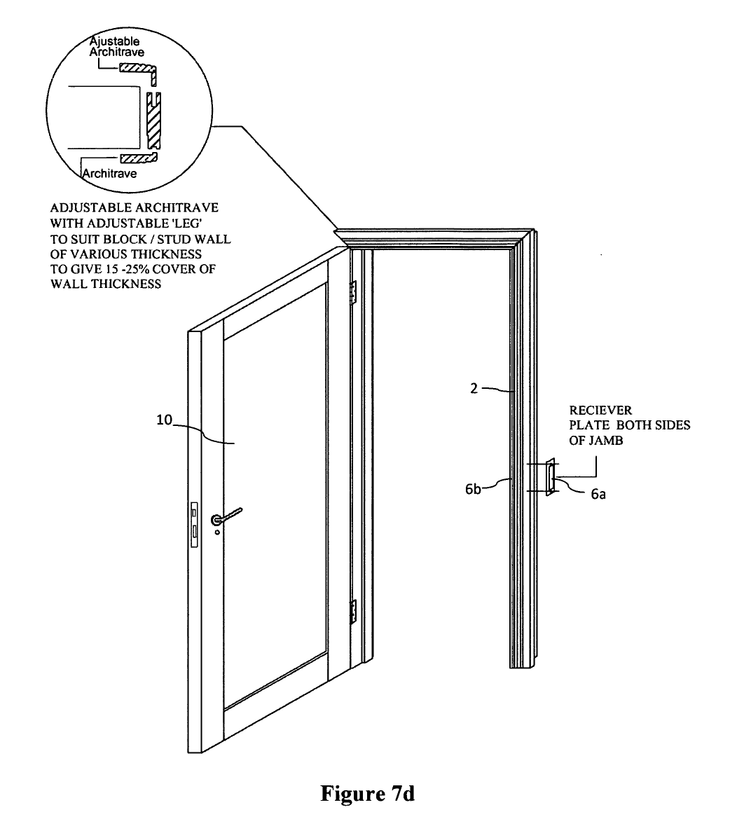

Referring to FIGS. 7a to 7d illustrates operation of the invention in different stages as to how the door frame and the door panel is hung. FIG. 7a illustrates how a support header engages the side walls to form said door frame. The means to engage comprises a single screw at each end of the support header, such that each single screw is centred across the width of the support header to allow the side wall to advantageously pivot on its axis. The single pivot screw simplifies the assembly process and also allows for easy reversing of the support walls of the frame. If adjustable frame is been used then the header of the frame must be removed and rotated 180 degrees and then connected to the side jambs. If a flat jamb frame is been used then there is no need to remove the header from the side jambs. Optionally extra screws can be added when final handedness of the door has been decided.

FIGS. 7b to 7d illustrate how the door panel is hung with the hinges of the present invention. The other wall support panel can form part of the door frame set to provide a support for the receiver plate. The side wall frame is routered on front and rear faces, thus making this wall frame reversible also. This allows for the side wall to be reversible also depending on which orientation the door panel needs to be hung. FIG. 7b shows how the door can be hung so both half hinges interlock. A pin is inserted in from the top for each hinge. In FIG. 7c the door stops are fixed to the sides and top of the frame and against the door when the door is in the closed position, as shown. FIG. 7d the architrave is fixed to both sides of the frame. If a ball bearing hinge is used just remove the door from the hinges then remove the hinge from the frame. Rotate the hinge 180 degrees and fix back onto the other routered pocket of the frame then finally latch the door to the hinges.

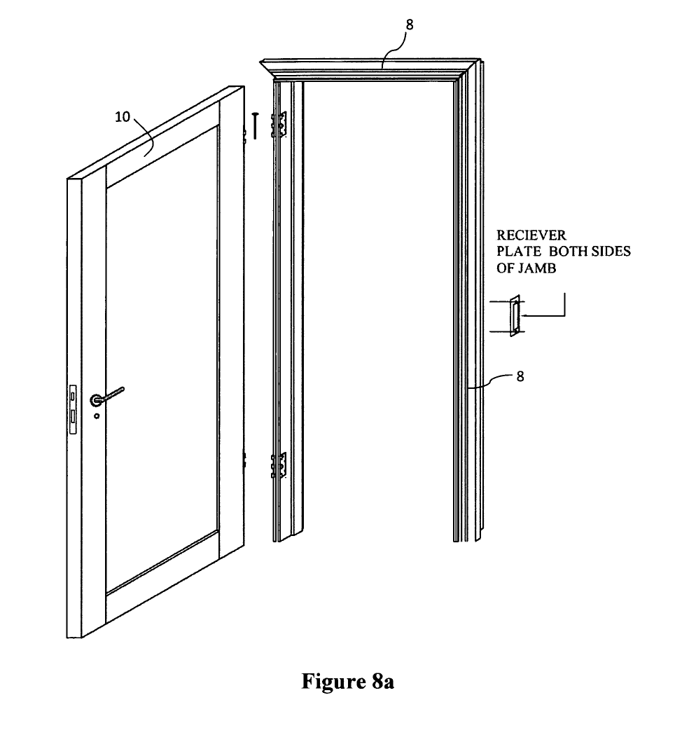

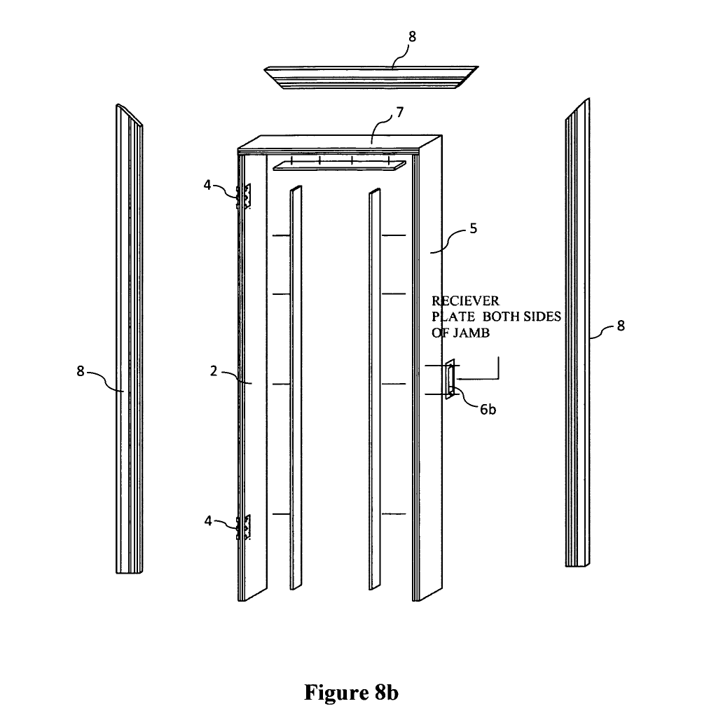

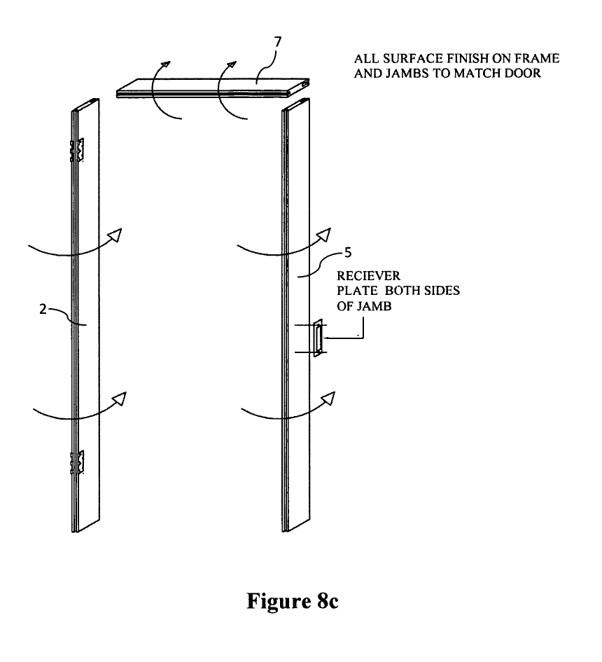

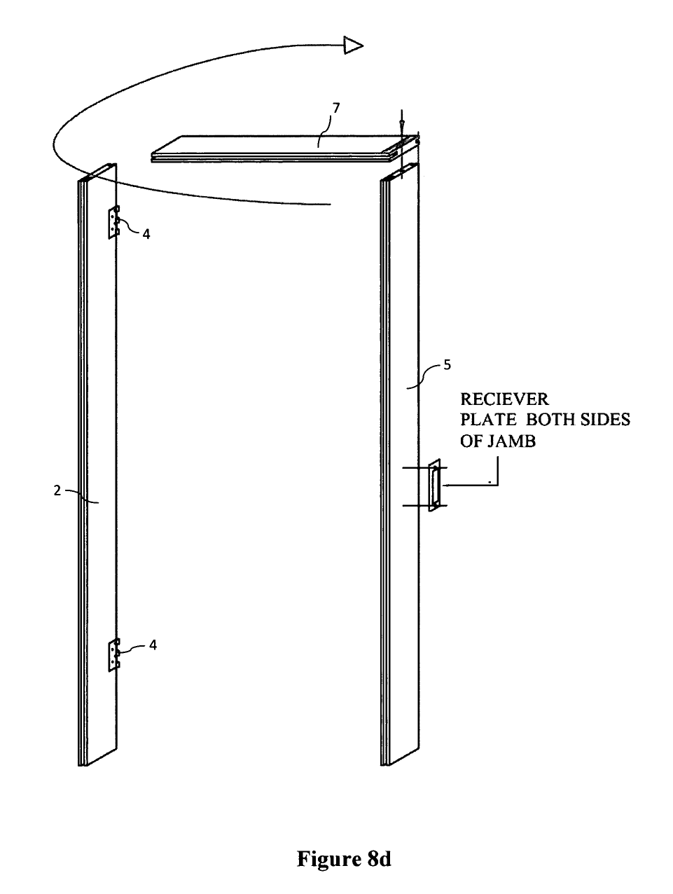

FIGS. 8a-8d illustrate various steps of reversing the door in the door frame. Once a door has been hung in its frame, it is a simple process to change the handedness of the door in the frame. FIG. 8a shows how the door can be disconnected by removing the pin from both hinges. FIG. 8b shows how the architraves and door stops can be easily removed as it is fixed normally with light pins. FIG. 8c illustrates that the first and second support side walls and the support header can be rotated as shown. The first and second supports are routered on both faces such that when the support members are reversed the support members can receive the hinges and the receiver plate. Once the side wall supports are rotated as shown in FIG. 8d the door frame assembly with the door frame can be assembled as describe with respect to FIGS. 7a-7d.

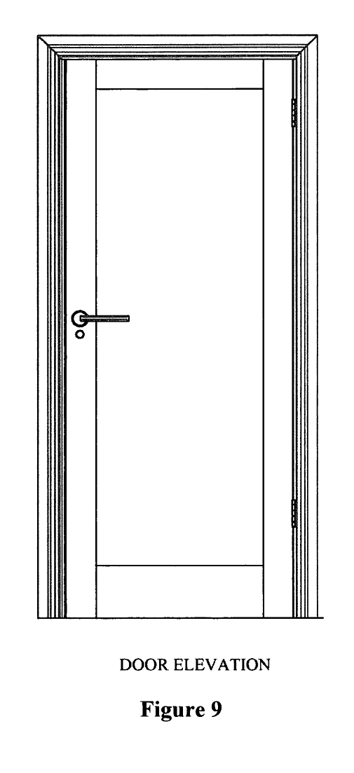

FIG. 9 illustrates the door panel closed in the door frame.

It will be appreciated that the door assembly may comprise a ‘finished’ veneer on all surfaces of the side wall supports. Alternatively the door frame assembly can be made of solid wood or a mixture of both wood and a veneer.

It will be appreciated that the term ‘routering’ means copying precisely from a template at a set depth, and in the context of the present invention routering is using a router to carve an image or an indentation on a piece of wood.

While the invention has been described herein with reference to several especially preferred embodiments, these embodiments have been presented by way of example only, and not to limit the scope of the invention. Additional embodiments thereof will be obvious to those skilled in the art having the benefit of this detailed description, especially to meet specific requirements or conditions. Further modifications are also possible in alternative embodiments without departing from the inventive concept.

The invention is not limited to the embodiments hereinbefore described but may be varied in both construction and detail.

1. A door frame assembly, suitable for hanging a door panel in a number of different positions, comprising:
at least one side wall support to form part of the frame to provide a support to hang a door panel using at least one hinge,
the side wall support routered on front and rear faces, such that either face is adapted to receive one plate of said hinge; and
one edge of the door panel routered across the entire thickness of the door panel edge to receive a second plate of said hinge, wherein the outer edge of the second plate comprises a bull nose edge.

2. The door frame assembly as claimed in claim 1 wherein a second side wall support of the frame comprises a routered portion to receive a receiver plate.

3. The door frame assembly as claimed in claim 1 wherein a second side wall support of the frame comprises a routered portion to receive a receiver plate and wherein the second side wall support is routered on opposing faces, both faces adapted to receive the receiver plate.

4. The door frame assembly as claimed in claim 1 wherein one edge of the door panel is bullnosed to match the bull nosed surface of the hinge to provide a smooth surface.

5. The door frame assembly as claimed in claim 1 comprising an adjustable architrave for attaching around the door frame.

6. The door frame assembly as claimed in claim 1 comprising an adjustable architrave for attaching around the door frame, wherein the adjustable architrave comprises a leg for engaging the door frame to suit different block/stud wall dimensions.

7. The door frame assembly as claimed in claim 1 comprising a flat jamb architrave for attaching around the door frame.

8. The door frame assembly as claimed in claim 1 wherein the side wall supports each comprise a ‘finished’ veneer on all surfaces of the side wall supports.

9. The door frame assembly as claimed in claim 1 wherein the side wall supports comprises natural wood or multi layered veneered wood.

10. The door frame assembly as claimed in claim 1 wherein a support header comprises means to engage the side walls to form said door frame.

11. The door frame assembly as claimed in claim 1 wherein a support header comprises means to engage the side walls to form said door frame and wherein the means to engage comprises a single screw at each end of the support header, such that each single screw is centred across the width of the support header to allow the side wall to pivot on its axis to reverse the side wall as necessary.

12. The door frame assembly as claimed in claim 1 wherein a support header comprises means to engage the side walls to form said door frame and wherein the means to engage comprises two or more screws to provide extra strength of the frame assembly.

13. The door frame assembly as claimed in claim 1 wherein the hinge comprises optional bearings.

14. The door frame assembly as claimed in claim 1 wherein the part of the hinge to engage with the door panel is dimensioned to be substantially equal the width of the door panel.

15. The door frame assembly as claimed in claim 1 in which the hinge comprises the first plate and second plates.

16. The door frame assembly as claimed in claim 1 in which the hinge comprises the first plate and second plates and wherein the first plate is releasably connectable to the second plate of the hinge.

17. The door frame assembly according to claim 1 in which the hinge comprises the first plate and second plates and wherein the first plate is releasably connectable to the second plate of the hinge and wherein the connection is by way of a removable pin which passes through a receptor means on each part.

18. A method of assembling a door frame assembly according to claim 1.

19. (canceled)

20. A hinge suitable for incorporating in the door assembly of claim 1 comprising at least one plate, wherein one edge of the plate comprises a bull nose edge.

21. The door frame assembly as claimed in claim 1 wherein a support header comprises means to engage the side walls to form said door frame, and wherein the means to engage comprises a single screw at each end of the support header, such that each single screw is centred across the width of the support header to allow the side wall to pivot on its axis to reverse the side wall as necessary, and wherein the means to engage comprises two or more screws to provide extra strength of the frame assembly.
